(19) United States
(12) Patent Application Publication
(10) Pub. No.: US 2026/0319806 A1
(43) Pub. Date: Oct. 15, 2026

(54) METHOD FOR CONFIGURING A MICROCONTROLLER

(71) Applicant: Robert Bosch GmbH, Stuttgart (DE)

(72) Inventors: Thomas Winkler, Renningen (DE); Laura Quitadamo, Weissach (DE); Ulli Hoffmann, Niefern-Oeschelbronn (DE)

(21) Appl. No.: 19/436,005

(22) Filed: Dec. 30, 2025

(30) Foreign Application Priority Data
Jan. 17, 2025 (DE) 10 2025 101 600.3

(51) Int. Cl. G06F 9/4401; G06F 9/22

(52) U.S. Cl. CPC G06F 9/4411; G06F 9/226

(57) ABSTRACT

A method for configuring a microcontroller that is connected to a host system via a data exchange link. The method includes: a) storing a representation of a configuration to be achieved, in the form of configuration data and configuration routines, in a flash memory of the microcontroller, wherein the configuration data and the configuration routines are stored separately from one another in the flash memory; b) transferring and storing the configuration data in configuration registers using a bootloader for configuring the microcontroller; and after configuration, deleting the configuration routines from the flash memory.

### BACKGROUND INFORMATION

With regard to the segment of embedded components, a clear trend toward steadily increasing complexity has been observed over the years. Especially in the case of microcontrollers (μC), a trend toward ever greater variety in terms of computing power and extensive peripheral functions is emerging.

At the same time, there is a movement toward the implementation of microcontrollers in segments that were previously reserved for discrete electronics. Particularly in this field, due to the enormous cost pressure, the careful use of resources is essential for the progressive development of new market segments.

On the development side, the flexible configuration of hardware is the main focus of continuous improvement. Graphic user interfaces have been used for this purpose for some time now and are already integrated into many development environments. They are typically used to generate a program code to be executed by the μC, the invocation of which takes place after the boot process but before the actual operating function. This allows the configuration of the μC and peripheral modules that is desired by the developer to be achieved. These routines, along with the program components required for the actual operating function, are stored in the internal read-only memory (flash memory or non-volatile memory) as part of the user program to be executed, so that they are available on each restart. In the sequence of events, the configuration of the microcontroller precedes the actual operating function.

While this is generally considered unproblematic for feature-rich hardware, it poses a significant problem for inexpensive μCs with limited resources.

Experiments with μCs show, for this case, that such configuration routines alone create significant memory requirements, which can occupy up to one third of the read-only memory of smaller controllers. This is because a comparatively substantial amount of program code must be executed in advance of the actual user program. Likewise, the boot process and thus the system readiness are delayed, resulting in disadvantages for time-critical and safety-critical applications.

The only solution currently available to developers is to resort to μCs with greater available memory and higher processing power. However, this can cause some applications to miss the cost optimum.

### SUMMARY

The present disclosure provides a novel method for configuring a microcontroller which significantly reduces the described disadvantages in terms of memory requirements and booting time.

According to an example embodiment, a method for configuring a microcontroller having configuration registers for receiving configuration data and a non-volatile memory, wherein the microcontroller is connected to a host system via a data exchange link for the purpose of programming the microcontroller, is provided herein, the method comprising the following steps:
a) storing a representation of a configuration to be achieved, in the form of configuration data and optional configuration routines, in the non-volatile memory of the microcontroller by means of the host system for programming the microcontroller, wherein the configuration data and the configuration routines are stored separately from one another in the non-volatile memory of the microcontroller;
b) transferring and storing the configuration data in configuration registers for configuring the microcontroller as part of a boot process of the microcontroller; and
c) after configuration, deleting the configuration routines from the non-volatile memory.

According to an example embodiment, step a) is carried out in particular by the host system, wherein the microcontroller is optionally also involved here (in particular in storing the configuration data and configuration routines). Step b) is preferably carried out by the microcontroller, preferably without the involvement of the host system. In embodiments, step c) is carried out only by the microcontroller, without the involvement of the host system. In other implementation variants, step c) is carried out with the involvement of the host system.

The microcontroller can, for example, be a microcontroller in embedded systems for small-signal and/or data processing.

According to an example embodiment, the host system can be a computer or a device that serves as a central platform to support, control, or read out other systems, processes, or services. The term is used in various contexts, with its exact meaning depending on the specific environment. In general, the term “host system” within the meaning of this application can be understood as a system that is used to program the microcontroller. The host system can be a computer that is used to develop programs for the microcontroller. The method described here is particularly preferably carried out in the context of tests that a developer performs with the microcontroller to determine whether programs developed for the microcontroller behave as expected when running on the microcontroller. In this implementation variant, the host system is therefore preferably configured to always carry out the described method with different configuration data and optional configuration routines for a specific individual microcontroller of a specific type when the developer wishes to test the microcontroller or a program developed for the microcontroller again/in a new program version.

In other implementation variants of the described method, the host system can also be a system that is used in manufacturing to configure microcontrollers installed in products for their particular application within the product. In this case, the host system is thus set up to carry out the described method in the same manner for a plurality of microcontrollers (with the same configuration data and optional configuration routines).

The configuration register can, for example, be a periphery register.

As used herein, the term “boot process” can be understood as a sequence that is executed first when a microcontroller is started. The step b) described herein, i.e., the configuration of the microcontroller described in step b), is performed as a final step of the boot process, before the actual program execution. The configuration performed during the boot process described in step b) is also commonly referred to as a “config boot.”

In other words, the core of the method described here can be seen in the creation and use of a compact representation of the desired configuration for microcontrollers and peripheral modules. This representation is stored in the internal read-only memory, read during the boot process, and copied to the corresponding register addresses. Preferably, the representation is so complete that, by transferring the representation into configuration registers of the microcontroller, all configuration registers of the microcontroller are set.

The memory requirements for the transfer function needed to transfer the values of the representation from the read-only memory to the configuration registers are considerably lower compared to other configuration methods where no (complete) representation of the desired configuration is transferred, but where a programmatic configuration solution is used.

In one example embodiment, the representation contains the configuration to be achieved, in particular the configuration data and an address list having configuration data to be stored.

In other words, the representation contains minimum information, reduced in terms of the instruction set, in an easy-to-handle format as a sequential sequence of addresses and values. The representation therefore preferably represents the core information, which contains the target addresses and values to be stored.

According to a further example embodiment, the bootloader is in the form of a config bootloader. For the purposes of the present disclosure, the term “config bootloader” can be understood as a specialized bootloader that not only loads a user program that is to be executed (later) on the microcontroller, but also processes configuration data and settings during the boot process.

In particular, a config bootloader offers the advantage of being flexibly usable and configurable. This means it allows the behavior of the system to be adjusted at runtime, e.g., by selecting from a range of predefined configurations.

Furthermore, it can be advantageous if the bootloader is executed as a memory copy routine. For the purposes of this application, the term “memory copy routine” or, in short, “mem copy routine” can be understood as a function or mechanism that copies data from one memory area to another memory area. In the context of a bootloader, it plays a crucial role, because bootloaders often need to load data, such as operating system kernels, drivers, or initialization information, from a memory location (e.g., flash memory, non-volatile memory, hard drive) into the working memory (RAM).

The advantage of this example embodiment is that the bootloader, in the form of a mem copy routine, is significantly simpler and more memory-efficient than the program code used in the related art. This reduces the memory requirements and runtime of the bootloader during the boot process or during the configuration process for setting up the configuration registers.

According to a further development of the present disclosure, the bootloader is executed as a separate module in the microcontroller.

In other words, the bootloader is preferably not part of the non-volatile memory that is used to execute programs on the microcontroller, and in particular not part of a processor of the microcontroller with which the programs for which the microcontroller is intended to be used are executed. Rather, the bootloader is executed separately therefrom as a separate module that serves to transfer the data, which are present in a standardized format, into the configuration registers.

Thus, for the boot process, i.e., for the configuration process for setting up the communication registers, any processor involvement in the configuration process is advantageously eliminated, so that the memory requirements required therefor can be reduced to a minimum.

In an alternative embodiment, before step a), a configuration program is loaded from the host system into the non-volatile memory and, during the configuration of the microcontroller, a representation of the configuration data is extracted by the bootloader, wherein the representation is stored in the non-volatile memory for new configurations and the configuration routines are deleted after configuration. The bootloader is preferably designed as an external module.

According to a further alternative embodiment, before step c), the configuration data stored in the configuration registers are read out, wherein the representation is created on the basis of the read out configuration data and the representation is stored in the non-volatile memory.

This provides an alternative embodiment while simultaneously saving memory space. This embodiment has proven particularly advantageous for fully readable configuration registers.

The possibility of extracting the representation of the configuration to be achieved from configuration registers preferably leads to the same result as if the representation was created beforehand and outside the microcontroller using an external tool (in particular using a host system). The possibility of extracting the representation from the configuration registers is a further way to obtain this representation and to use the new method. The creation of the representation can then be carried out in particular upstream of step a) in order to create the representation stored/used in step a). In some implementation variants of the method, it is then possible to create the representation with a test microcontroller that is of the same type as the microcontroller that is configured using the described method. This implementation variant is in particular advantageous when the external means (the host system) alone are not able to create the exact representation.

The configurable microcontroller, which is also disclosed herein, comprises a non-volatile memory and a bootloader, wherein the non-volatile memory and the bootloader are set up to configure the microcontroller according to the above-described method.

Advantages and preferred embodiments disclosed herein with regard to the method can be applied analogously to the configurable microcontroller and vice versa.

The present disclosure and the technical environment are explained in more detail below with reference to the figures. The figures show preferred exemplary embodiments, to which the present disclosure is not limited. It should be noted, in particular, that the figures and in particular the size proportions shown in the figures are only schematic.

### BRIEF DESCRIPTION OF THE DRAWINGS

FIG. 1 shows a schematic block diagram of a configuration process of a configurable microcontroller according to the related art.

FIG. 2 shows a schematic block diagram of a configuration process according to the present disclosure according to a first example embodiment.

FIG. 3 shows a schematic block diagram of a configuration process according to the present disclosure according to a second example embodiment.

FIG. 4 shows a schematic block diagram of a configuration process according to the present disclosure according to a third example embodiment.

FIG. 5 shows a schematic block diagram of a configuration process according to the present disclosure according to a fourth example embodiment.

FIG. 6 shows a schematic block diagram of a configuration process according to the present disclosure according to a fifth example embodiment.

### DETAILED DESCRIPTION OF EXAMPLE EMBODIMENTS

In the figures, the same or functionally identical components are provided with the same reference signs.

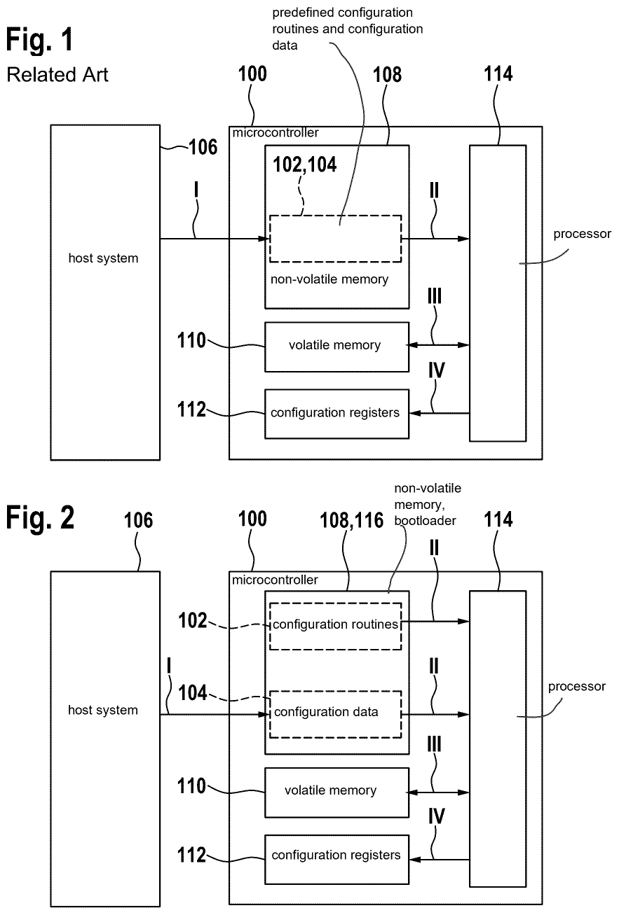

FIG. 1 shows a configuration process according to the related art. In this process, a microcontroller 100 to be configured receives predefined configuration routines 102 and configuration data 104 from a host system 106, in programming step I. The configuration routines 102 contain, in addition to the configuration data 104, a portion of program code that is significant in terms of memory requirements. The configuration routines 102 and the configuration data 104 are stored in a non-volatile memory 108. This process can generally also be referred to as a programming process.

During a system start-up of the microcontroller, i.e., following the conventional boot process according to the related art, the configuration data 104 are extracted in the course of program execution and, with the involvement of required calculation steps (step III), which can be carried out in a volatile memory (Static Random Access Memory (SRAM) ) 110, are transferred to a target position (step IV). The target position is configuration registers 112. For the sake of simplicity, the configuration registers 112 are shown merely schematically in the form of a rectangle.

The aforementioned configuration steps are preferably performed by a processor 114, which is part of the microcontroller 100.

The disadvantage of this embodiment is that, following the boot process, information no longer needed for the further operation of the microcontroller 100, in particular the configuration routines 102, remains in the non-volatile memory 108 for the next boot process, where it occupies valuable memory space, which is therefore no longer available for the operating function.

This is where the method according to the present disclosure comes in, wherein a first embodiment of the method according to the present disclosure is shown in the form of a block diagram in FIG. 2.

The essential difference from the method according to the related art described with reference to FIG. 1 is that, in step I, the host system 106 merely stores a representation of a configuration to be achieved, in the form of configuration data 104 and configuration routines 102, in the non-volatile memory 108 of the microcontroller 100. The representation provides the core information for configuring the microcontroller 100 and preferably includes the target addresses and the values to be stored. In this case, the configuration data 104 and the configuration routines 102 are stored separately from one another in the non-volatile memory 108.

Then, a bootloader 116 belonging to the non-volatile memory 108 is loaded. The bootloader 116 serves to transfer (step II) and store (step IV) the configuration data 104 in configuration registers 112 for the configuration of the microcontroller 100 based on the configuration routines 102. This can, for example, as already explained with reference to FIG. 1, also be done based on calculation steps (step III) using the volatile memory 110.

In contrast to the related art, the configuration routines 102 can be significantly more space-saving here due to the advantageously selected format of the configuration data, resulting in a lower memory requirement.

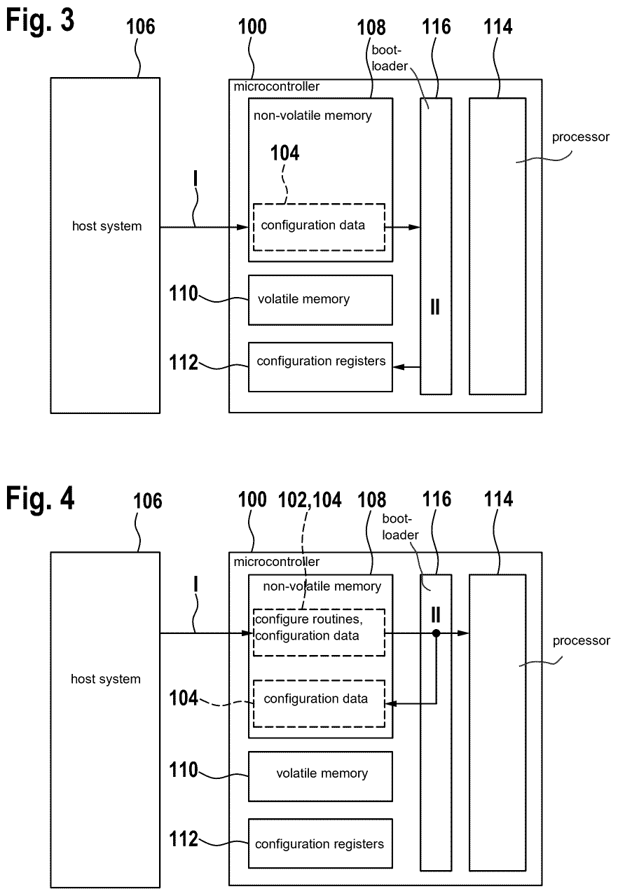

FIG. 3 shows a second embodiment of the method according to the present disclosure in the form of a block diagram. In principle, the embodiment shown corresponds to the embodiment according to FIG. 2.

The essential difference, however, is that the bootloader 116 is executed as a separate module for transferring (step II) the configuration data 104 previously transferred to the non-volatile memory 108 (step I) into the configuration registers 112.

This embodiment therefore eliminates any involvement of the processor 114 in the configuration process, thus reducing the memory requirements to a minimum.

A third embodiment is shown in the form of a block diagram in FIG. 4.

In this embodiment of the method for configuring the microcontroller 100, the configuration routines 102 and the configuration data 104 are first stored in the non-volatile memory 108 (step I), as already described with reference to FIG. 1 according to the related art.

Then, the configuration routines 102 and the configuration data 104 are routed through the bootloader 116, which is in the form of a separate module. There, the minimum information for configuration is extracted in the form of configuration data 104 and stored in the non-volatile memory 108 (step II). This stored information is then used to configure the microcontroller 100, so that the program initially provided by the host system 106 is no longer needed and can be removed from the non-volatile memory 108.

This embodiment has the advantage that the resource-saving approach can also be achieved using a conventional development environment (according to the related art) if it does not allow the configuration data 104 to be stored directly.

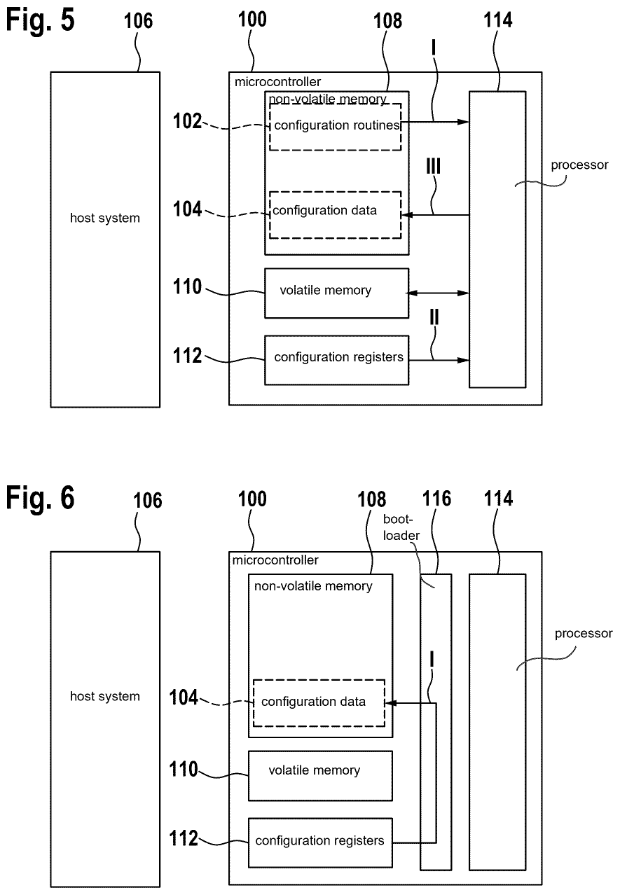

An alternative embodiment is shown as the fourth embodiment in FIG. 5.

This information can be read out following a traditional configuration method according to the related art. In the present example, this is preferably performed inversely to the approach shown in FIG. 2.

Specifically, this means that, preferably with the aid of software (step I), e.g., by means of the program config-dump, the configuration data 104 are read by the processor 114 and by the bootloader 116 from the configuration registers 112 (step II), and the representation is created based on the read out configuration data 104 (step III). The term “config dump” within the meaning of the present disclosure can be understood as a method or process in which the current configuration of a system, software, device or application is exported and stored in a readable form. The term “dump” here refers to the fact that the configuration is output in its entirety or in a specific format.

This embodiment of the method has proven particularly advantageous in the case where the configuration registers 112 are fully readable.

The same method as in FIG. 5 can also be carried out if the bootloader 116 is in the form of a separate module. This is shown schematically in the fifth embodiment in FIG. 6.

Information about the register values that have changed compared to a standard configuration can be used to ensure the most memory-efficient storage of the representation. This information can be obtained by determining the difference between all register values before and after configuration. This makes it possible to avoid the need to represent the entire peripheral area, and to generate only the required minimum set of configuration data for the configuration in question.

The minimum information for configuring the microcontroller 100 and the peripheral area in the form of the memory representation preferably, but not exclusively, consists of an address list along with the data to be stored. In the simplest case, an alternating sequence of the address and the corresponding data item can be used for this. If the addresses are consecutive, the list preferably begins with a start address, followed by an indication of the length of the data sequence. This is followed only by the data sequence of the aforementioned length, so that all address information between the start and end addresses of the sequence is omitted. This can additionally save a significant amount of memory.

Similarly, in one embodiment, relative jumps between addresses are possible, where, in contrast to explicit address information, position-independent lists are generated. This offers advantages when configuring a plurality of similar peripheral modules which ideally share a common list.

Furthermore, according to one embodiment, partial repetitions, loops, etc. are possible in order to achieve the most compact possible storage of the information. Ideally, appropriate selection options are available in the resource management of the development environment to best support developers in selecting the right strategy.

1-8. (canceled)

9. A method for configuring a microcontroller, the microcontroller including configuration registers for receiving configuration data, and a non-volatile memory, wherein the microcontroller is connected to a host system via a data exchange link for programming the microcontroller, the method comprising the following steps:
a) storing a representation of a configuration to be achieved, in the form of configuration data and configuration routines, in the non-volatile memory of the microcontroller, using the host system, for the programming of the microcontroller, wherein the configuration data and the configuration routines are stored separately from one another in the non-volatile memory of the microcontroller; and
b) transferring and storing the configuration data in the configuration registers for configuring the microcontroller as part of a boot process of the microcontroller.

10. The method according to claim 9, further comprising:
c) after configuring the microcontroller, deleting the configuration routines from the non-volatile memory.

11. The method according to claim 9, wherein the configuration data includes an address list having the configuration data to be stored.

12. The method according to claim 9, wherein a bootloader of the microcontroller performs step b), the bootloader being in the form of a config bootloader.

13. The method according to claim 12, wherein the bootloader is executed as a memory copy routine.

14. The method according to claim 9, wherein a bootloader of the microcontroller performs step b), the bootloader being executed as a separate module in the microcontroller.

15. The method according to claim 14, wherein, before performing step a), a configuration program is loaded from the host system into the non-volatile memory, and during the configuration of the microcontroller, the representation of the configuration is extracted by the bootloader, wherein the representation of the configuration is stored in flash memory for new configurations and the configuration routines are deleted after configuring the microcontroller.

16. The method according to claim 10, wherein, before performing step c), the configuration data stored in the configuration registers are read, wherein the representation of the configuration is created based on the read configuration data, and the representation of the configuration is stored in the non-volatile memory.

17. A configurable microcontroller, comprising:
a non-volatile memory; and
a bootloader;
wherein the non-volatile memory and the bootloader are set up to configure the microcontroller, and wherein the microcontroller is configured by performing the following steps:
a) storing a representation of a configuration to be achieved, in the form of configuration data and configuration routines, in the non-volatile memory of the microcontroller, using a host system connected to the microcontroller, for programming the microcontroller, wherein the configuration data and the configuration routines are stored separately from one another in the non-volatile memory of the microcontroller, and
b) transferring and storing the configuration data in configuration registers of the microcontroller for configuring the microcontroller as part of a boot process of the microcontroller.
